(19) United States
(12) Patent Application Publication
(10) Pub. No.: US 2017/0240397 A1
(43) Pub. Date: Aug. 24, 2017

(54) A Load Handling Apparatus For A Forklift

(71) Applicant: Safe Loan Systems Limited, Cumbria (GB)

(72) Inventor: Brian Eaglestone, Cumbria (GB)

(21) Appl. No.: 15/118,828

(22) PCT Filed: Feb. 16, 2015
(86) PCT No.: PCT/GB2015/050437

§ 371 Date: Aug. 12, 2016

(30) Foreign Application Priority Data
Feb. 14, 2014 (GB) 1402656.1

(51) Int. Cl. B66F 9/12; B66F 9/24

(52) U.S. Cl. CPC B66F 9/125; B66F 9/24

(57) ABSTRACT

A load handling apparatus for a load handling vehicle such as a forklift including a rear load handling section including mounting means for securing the rear load handling section to the lifting mechanism of a forklift mast assembly. A front load handling section in use supports the load. The front load handling section is rotatably mounted to the rear load handling section, such that the front load handling section is able to rotate relative to the rear load handling section. The load handling apparatus has a lateral axis transverse to the rotational axis of the front load handling section. Actuating means are arranged to rotate the front load handling section relative to the rear load handling section, and an attitude sensor is configured to provide a signal indicative of the lateral attitude of the rear load handling section (38) relative to the horizontal.

The present invention relates to a load handling apparatus for a load handling vehicle such as a forklift, and in particular to an automatic self-levelling load handling apparatus.

Forklift Trucks, including Rough Terrain Forklifts and Telescopic forklifts are industrial vehicles that are commonly used as the preferred means of lifting moving heavy loads and goods across short distances. A forklift truck comprises a motor driven vehicle, referred to as a truck having a vehicle frame to which is mounted a lifting mechanism. The lifting mechanism comprises forks (also known as blades or tines) slidingly mounted to a carriage plate which runs vertically within parallel vertical guides collectively known as a mast. The mast is typically located at the front of the vehicle, with the fork carriage being attached to the front of the mast such that the forks extend substantially horizontally away from the front of the mast, attached to the fork carriage vehicle. One or more hydraulic cylinders is connected to the mast assembly and arranged in a vertical orientation to raise or lower the carriage to which the forks are attached to raise and lower the forks. Hydraulic controls also enable the operator to tilt the mast fore and aft to compensate for a load tipping forwardly or rearwardly when supported on the forks, as well as the limited ability to level the load with the surface onto which it is being loaded.

Forklift hydraulics are controlled with either levers directly manipulating the hydraulic valves, or by electrically controlled actuators, using smaller finger levers for control. In both cases, the levers are operated directly by the operator to effect control of the forks.

The horizontal attitude of the forks is linked to the horizontal attitude of the wheelbase of the truck. Any variation in the horizontal attitude of the forks translates to a variation in the vertical attitude of the load supported on the forks. In the longitudinal direction the horizontal attitude of the forks relative to the truck may be varied be pivoting the mast towards or away from the truck. This relies on the operator being responsive to changes in the level of the floor and operating the hydraulic controls accordingly to compensate for uneven floors and driving at speeds commensurate to the size, weight and load being carried. In the transverse direction, relative to the longitudinal axis of the vehicle and its direction of travel the transverse horizontal attitude of the forks is directly linked to the horizontal attitude of the wheelbase of the truck due to the transverse horizontal attitude of the forks being fixed relative to the truck. Forklift trucks therefore require a substantially flat surface on which to operate to avoid tipping of the load, particularly in the transverse direction.

A flat floor environment is typically only consistently available within an internal environment such as a warehouse or shop floor. Such environments may still include uneven surfaces and therefore constant skill and diligence is required from the forklift truck operator to maintain the load. In eth external environment, such as a loading yard and areas designated as loading areas, the floor is far more uneven. Even a smooth and substantially unbroken surface will generally have been constructed with a fall gradient towards surface water drains. As such, the surface will inherently have a slope in the region of 1% to 6%.

A further critical consideration in the operation of a forklift is the instability of the vehicle due to the effect of load on its centre of gravity while moving. The centre of gravity of a forklift continually varies with every movement of the load. Centrifugal and gravitational forces vehicle moves to create a tipping force that may result in a tip-over accident as the vehicle is moving. For this reason a forklift operator must be very cautious when turning the vehicle and maintain a speed that is appropriate for the size and weight of the load.

Due the uneven nature of the surfaces on which many forklift trucks are operated, and due to operator error in not properly considering the weight of the load, accidents involving forklifts and their loads toppling over are not uncommon. Toppling accidents may also occur. The resulting risk of injury to the operator, as well as the associated cost and loss of time of such accidents is highly undesirable.

It is therefore desirable to provide an improved load handling apparatus for a load handling vehicle such as a forklift which addresses the above described problems and/or which offers improvements generally.

According to the present invention there is provided a load handling apparatus for a load handling vehicle as described in the accompanying claims. There is also provided a load handling vehicle as described in the accompanying claims.

In an embodiment of the invention there is provided a load handling apparatus for a load handling vehicle such as a forklift, the apparatus comprising a rear having a front face and a rear face. The rear section includes mounting means for securing the rear section to the lifting mechanism of a forklift. A front is mounted to rear section in front of its front face. The front section is configured to support a plurality of loading tines extending forwardly away from the front face. The front section is rotatably mounted to the rear section to enable the front section to rotate relative to the rear section to maintain the loading tines in a substantially horizontal attitude when the rear section is rotated.

The rear section is fixed to the lifting mechanism of a load handling vehicle, such as to the vertical hydraulic lifting cylinder of a forklift, and the associated telescopic mast assembly. As such the rear section is laterally fixed relative to the vehicle, and any lateral rotation of the vehicle results in lateral rotation of the rear section. As the front section is able to rotate laterally relative to the rear section, it is able to maintain a substantially horizontal attitude while the rear section rotates away from the horizontal, thereby maintaining the load in a substantially vertical attitude to mitigate the risk of tipping.

In another aspect of the invention there is provided a load handling apparatus for a load handling vehicle such as a forklift, the apparatus comprising a rear load handling section including mounting means for securing the rear load handling section to the lifting mechanism of a forklift mast assembly. A front load handling section is provide which in use supports the load, and is rotatably mounted to the rear load handling section, such that the front load handling section is able to rotate relative to the rear load handling section, the load handling apparatus having a lateral axis transverse to the rotational axis of the front load handling section; actuating means arranged to rotate the front load handling section relative to the rear load handling section; an attitude sensor configured to provide a signal indicative of the lateral attitude of the rear load handling section relative to the horizontal. A controller is configured to automatically control the actuating means in response to a signal from the attitude sensor to rotate the front load handling section relative to the rear load handling section to optimise load stability.

As such, the system automatically stabilises the load laterally without requiring any operator interaction, control or judgement. Typically the front load handling section will be rotated to a substantially horizontal lateral attitude to optimise stability of the load. However, in conditions where the vehicle is turning, inertial forces and in particular centrifugal forces must be considered. In order to account for such forces the front load section may be rotated to a lateral attitude away from the horizontal and in particular and attitude oriented radially inwards inclination relative to the arc of turning thereby moving the centre of gravity away from the centre line of the load to counteract the centrifugal force. The attitude sensor is able to generate a signal indicative of the inertial forces experienced by the vehicle and the controller compensates for such forces by determining the required angle of rotation of the front loading section.

The load handling apparatus may have a longitudinal axis extending parallel to the rotational axis of the rotational mounting which in use aligns with the longitudinal axis of the load handling vehicle with the longitudinal horizontal attitude of the front load handling section being define by the position in which the longitudinal axes of the lifting tines are horizontally arranged. The attitude sensor, which may include a plurality of sensors, is configured to provide a signal to the controller indicative of the longitudinal horizontal attitude of the vehicle, and the controller is configured to generate a control signal in response to said signal to in use control the mast assembly actuator of a forklift truck to alter the in a longitudinal attitude of front load handling section relative to the horizontal to optimise load stability. The controller determines the optimum longitudinal attitude of the front load handling section relative to the horizontal to optimise load stability.

As such, the system automatically stabilises the load longitudinally without requiring any operator interaction, control or judgement. Typically the front load handling section will be pivoted to a substantially horizontal longitudinal attitude to optimise stability of the load. However, in conditions where the vehicle is accelerating or decelerating, inertial forces must be considered. In order to account for such forces the front load section may be pivoted to a longitudinal attitude away from the horizontal and in particular inclined forwardly when the vehicle is accelerating to counter the rearward inertial force, and rearwardly when the vehicle is decelerating to counter the forward inertial force. The attitude sensor is able to generate a signal indicative of the inertial forces experienced by the vehicle and the controller compensates for such forces by determining the required angle of rotation of the front loading section longitudinally.

The front and rear sections may be substantially planar and may be solid planar panels, planar frame work sections comprising frame elements arranged in the same vertical plane, or a combination of both. The front and rear sections are vertically arranged in use with their front and rear faces being substantially vertical and having horizontal upper and lower edges.

A plurality of tines may mounted to the front face of the front section with at least a portion of the tines extending forwardly away from the front face in a direction substantially perpendicular to the front face with the tines being vertically aligned relative to the front face. The tines may be L-shaped with a vertical section secured to the front face and a perpendicular load receiving section extending forwardly proximate the lower edge of the front section. It an alternative embodiment other specialised carriers elements may be attached instead of tines for specific jobs, for example for handling hazardous waste and chemicals.

The horizontal attitude of the front load handling section is defined as the rotational position in which the lifting tines are substantially vertically aligned.

An actuator may be provided that is arranged to rotate the front section relative to the rear section. While it is contemplated that the front section may passively rotate to maintain its horizontal attitude, this may lead to excessive swaying or lateral oscillation of the load. While damping could be provided to mitigate this, it is preferable that the lateral rotation of the load is actively controlled by an actuator. The use of an actuator enables the precise relative rotational position of the front section to be achieved. It also allows the apparatus to be actively controlled by the operator when loading or unloading to control the horizontal attitude of the tines.

The actuator is a preferably a linear actuator, such as a hydraulic actuator having a first is end rotatably mounted to the rear section and a second end rotatable mounted to the front section at a location radially spaced from the rotational mounting. This mounting arrangement allows the linear actuator to effect rotational movement of the front section.

A projection extends from the rear face of the front section to which the second end of the linear actuator is rotatably mounted. The projection is preferably a pin or cylindrical lug or other element forming an axle for rotation.

The linear actuator may be mounted to the rear face of the rear section and the rear section comprises an arcuate slot through which the projection of the front section extends. The slot has a radius corresponding to the distance from the centre of rotation of the rotatable mounting connecting the front and rear sections to the centre of rotation of the projection. As such the slot follows the rotational arc of the projection, and allows a substantially solid rear panel to be maintained for maximum stability while allowing movement of the projection from the rear.

The load handling apparatus preferably has a lateral axis arranged parallel to the front face of the front panel, and may further comprise an attitude sensor for detecting the lateral attitude of the load handling vehicle to which the load handling device is mounted, and a controller arranged to control the actuator in response to a signal from the attitude sensor to move the front section towards a laterally horizontal attitude in which the tines are substantially horizontal in the lateral direction. The sensor may be a gyroscope or any other suitable sensor able to detect a change in attitude. The sensor enables the front section and hence the load to be automatically levelled in response to a change in attitude of the vehicle without requiring operator intervention.

The apparatus may also have a longitudinal axis extending perpendicular to the front face in the same direction as the tines which in use aligns with the longitudinal axis of the load handling vehicle. The attitude sensor is preferably configured to provide a signal to the controller indicative of the longitudinal attitude of the vehicle. The controller may also be configured to connect to and control the pivoting actuator of the forklift controlling the attitude of the masts, to thereby adjust the longitudinal horizontal attitude of the tines to maintain them in a substantially horizontal attitude.

The load handling apparatus of the present invention is thereby able to maintain the load on the forks of the load handling vehicle in a substantially vertical position, independently of the lateral (side to side) and longitudinal (fore and aft) horizontal attitude of the vehicle. By maintaining the load vertically on the vehicle, the weight of the load is maintained with the lowest centre of gravity as is practical, thereby minimising the risk of tipping and maximise stability of the vehicle.

The present invention therefore increases the load carrying capacity of a forklift by maintaining the centre of balance of the load. Advantageously that when the vehicle including the system of the present invention is tested for load including an assessment of the vehicle tipping characteristics when carrying a load at height, the present system will allow a much increased lean angle before the forklift tips over, thereby enabling the vehicle to be rated for a much higher load than would otherwise be possible. This enables smaller vehicles to be provided with a higher load capacity, enabling operators to purchase smaller and hence cheaper vehicles for the same load handling operations that previously required a much larger vehicle.

The automated nature of the self-levelling system is such that the operator will largely be unaware of the system in use, unless the forklift truck is operated outside of its operating parameters. Preferably the system comprises means for logging data relating to the operation of the levelling system, enabling assessment and review of operator performance and the degree to which care is taken in moving the goods. The system may also include a GPS data logger for logging data relating to the transport of the load. The system may also include for real-time video capture to record load handling evens, to assist in improving operator awareness in the event of an incident via post incident review.

The controller may include solid-state and SMT technology incorporated into the main system ECU, as well as means for integrating the system with the existing fork truck operating systems thereby facilitating retro fit of the system.

The system will also be capable of automatically raising the height of the forks as the truck moves, to stop the load from dragging on the floor and tipping off. This enhancement will also save wear to the forks.

The system may also include means for automatic raising the forks to a suitable transport-height to avoid damage to the forks and load. A significant number of forklift truck accidents and damage to palletised goods occur when a fork lift is driven at operating speed with the pallet to close to the ground resulting in the pallets and/or forks impacting or dragging on the ground while the vehicle is moving. The pallets and their raising blocks are regularly smashed off causing issues when it comes to loading and unloading the palletised goods again. This also results in a significant cost in replacing the tines on a regular basis. In an embodiment of the invention the system detects when the vehicle is moving at operating speed and automatically operates the forks to raise to a predetermined minimum height to prevent them from dragging. An operator override may be provided to enable to enable the loading of exceptional loads. This will help prevent to prevent the possibility of the load being dragged off of the truck as the load contacts the floor, whilst the truck is manoeuvring backwards, as well as saving the company operating the forklift trucks, vast sums of down-time and money which is being spent on fork replacements and damage to pallets and goods.

The controller may include an override function to enable the apparatus to be directly controlled by the forklift truck operator. This will provide an enhanced level of control during loading and unloading, both at height and at vehicle bed height by enabling the operator to vary the lateral horizontal attitude of the load if it is not horizontally aligned with the surface to or from which it is being loaded. This will prove to be invaluable for certain industries where they load very heavy, long loads onto vehicles that may not have a flat, level load bed, i.e. brick and block, concrete products

The vehicle attitude sensor is preferably mounted to the forklift main chassis or the tines carriage. When the sensor detects that the forklift is not in a level horizontal attitude it sends a signal to the controller to operate a hydraulic valve block. The sensor itself may comprise or include the controller. Alternatively a separate control means may be included. The hydraulic valve block in turn supplies the correct amount of pressurised fluid to the forklift carriage front plate, or the main telescopic mast cylinders, to alter the fore-aft or side-to-side attitude of the load platform. Preferably the control system is configured to provide dampening delay or hysteresis to enable a smooth transition from one angle to the next. This actuation delay or damping advantageously avoids jerking or overcompensating movement, which could set up serious oscillations within the loaded forklift, causing destabilisation and possible damage to the operator, forklift truck or the goods being transported. Preferably the attitude sensor and actuator system includes one or more gyroscopes and one or more accelerometers. The accelerometers are configured to detect a change in attitude and to send a signal indicative of this change to the controller. Simultaneously the one or more gyroscopes provide information on the actual attitude of the vehicle. A comparison operation is conducted by the controller based on the accelerometer and gyroscope signals and on the basis of this operation the controller actuates the mast and carriage plate actuators to vary the fore and aft, and transverse attitude of the forks to maintain a level load.

The lateral load stabilisation may be also be activated and controlled solely by electronic means, including the use of an electric motor screw actuator for actuating relative rotation of the front and rear sections. Alternatively a motor may operate a drive gear, with a corresponding arcuate rack gear being mounted to the rear face of the front carriage plate, with the gears being arranged such that rotation of the drive gear causes corresponding rotation of the front carriage plate through translation of the arcuate rack gear.

The lateral actuators may be by operated by way of electronic motor driven, screw type actuator. Alternatively the actuator may be of the push-pull hydraulic cylinder type or a hydraulic motor driving a gear and quadrant gear system.

In another aspect of the invention there is provided a load handling vehicle comprising a load handling apparatus as described above and as set out in the claims.

The controller may be configured to determine the velocity of the vehicle and to override the vehicle controls and decelerate the vehicle when it is determined that the velocity exceeds maximum load stability parameters. The attitude sensor is capable of generating a signal indicative of the velocity including speed and direction. The maximum speed will vary depending on whether the vehicle is turning or operating in a straight line. The controller may also operate to limit acceleration and/or declaration to prevent forward or rearward tipping of the load.

The present invention will now be described by way of example only with reference to the following illustrative figures in which:

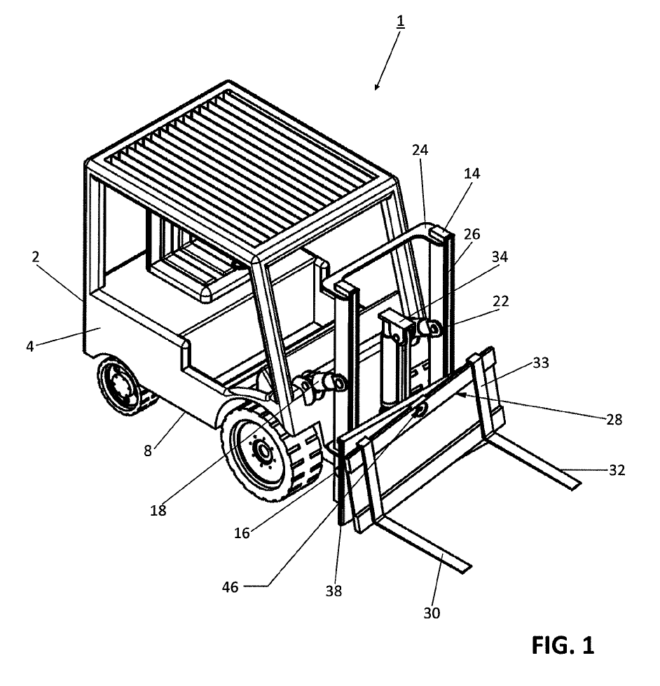

FIG. 1 shows a forklift truck including a load handling apparatus according to an embodiment of the invention;

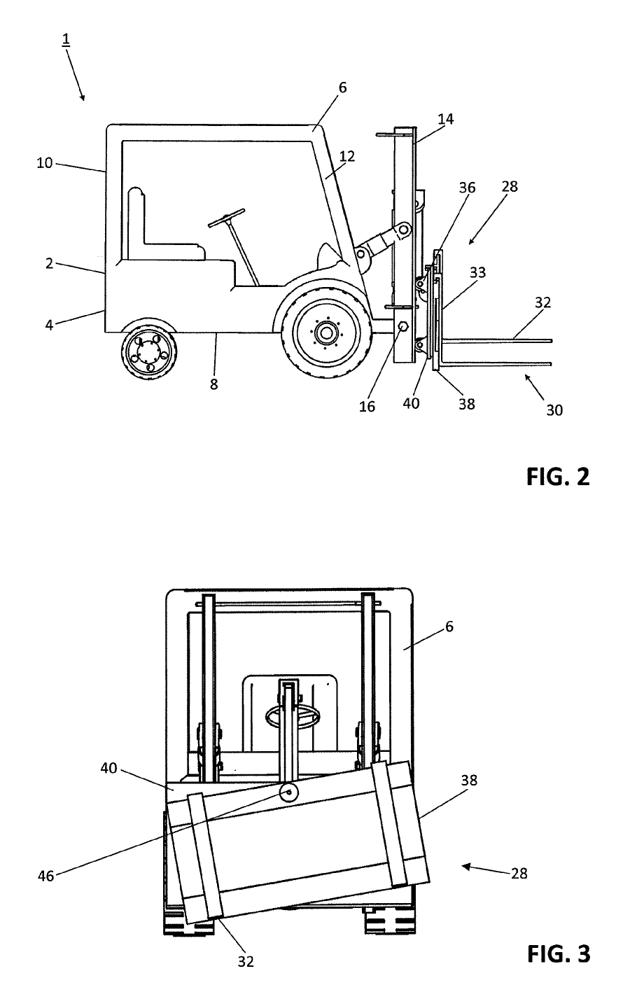

FIG. 2 is a side view of the arrangement of FIG. 1;

FIG. 3 is a front view of the arrangement of FIG. 1; and

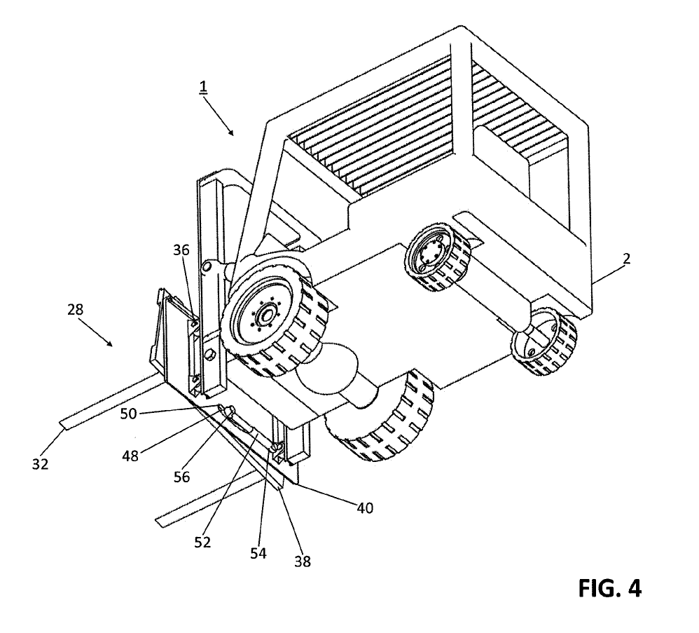

FIG. 4 is a view of the arrangement of FIG. 1 from below and to the rear.

Referring to FIG. 1, a forklift truck 1 comprises a truck 2 having a body 4 including a frame 6 and a wheel base 8. The truck 2 has a rear end 10 and a front end 12 with a longitudinal axis being defined between the front 10 and back 12 along the length of the vehicle in line with its direction of travel. Vertical supports or masts 14 are mounted to the frame or chassis 6 of the truck 2 at the front end 12. The mast assembly 14 is pivotally mounted to the frame 6 by pivotal mountings 16 which are located towards the base of the mast assembly. Hydraulic cylinders 18 are pivotally connected at a first end 20 to the frame 6 and at their distal ends 22 to the mast assembly 14.

As shown in FIG. 2 the mast assembly 14 includes a pair of vertically arranged elongate members which are laterally spaced by a distance less than the width of the truck 2. A pair of cylinders 18 is provided at either side at the front 12 of the truck 2 corresponding to the lateral locations of the mast assembly 14. Each cylinder 18 is secured to the corresponding mast 14 at a location vertically spaced above the pivot connection 16 connecting the corresponding mast 14 to the frame 6. The mast assembly 14 is connected at the upper ends by a bridging member 24 which reinforces and maintains the spacing of the mast assembly 14. Each mast 14 includes a guide channel 26 extending along its length at its front edge.

A load handling apparatus 28 is located in front of the mast assembly 14. The load handling apparatus 28 includes a pair of substantially L-shaped tines 30 each having a lift support section 32 extending forwardly in a substantially horizontal attitude. The load handling apparatus 28 is connected on its rear side to a hydraulic cylinder 34 secured to the truck 2. The cylinder 34 is substantially vertically oriented and secured to the rear side of the load handling apparatus 28 to raise and lower the load handling apparatus 28 in the vertical direction. As shown in FIG. 2 the rear side of the load handling apparatus 28 includes two pairs of rollers 36 arranged in a transversely spaced relationship with the rollers being aligned with and received within the corresponding channels 26 of the mast assembly 14. The channel 26 acts as a guide channel with the rollers 36 rolling within the guide channels 26 as the load handling apparatus 28 is raised and lowered by the cylinder 34.

The load handling apparatus 28 comprises a rear carriage plate 38 defining a rear section of the load handling apparatus, and a front carriage plate 40 defining a front section of the load handling apparatus 28. Fork tines 30 are secured to the front face of the front carriage plate 40 by upright sections 33 that form the rear section of the L-shaped tines, and are arranged such that the lifting section 32 of each tines extend substantially perpendicularly relative to the front carriage plate 40 away from the front carriage plate 40 proximate its lower. The front face of the front carriage plate 40 and the upright sections 33 of the tines 30 provide a vertical backstop for the load. The forks 30 are laterally spaced across the front carriage plate 40 and are located substantially at its outer edges with each fork 30 being spaced an equal distance inwardly from the outer edge of the front carriage plate 40.

The front carriage plate 40 comprises a substantially rectangular panel 42 and may also include lateral reinforcing members 44 located at the upper and lower front edges. As shown in FIG. 3 the front carriage plate 40 is secured to the rear carriage plate 38 by a rotational mounting 44. The rotational mounting is preferably a bearing assembly such as a needle bearing assembly, although a bush arrangement is also contemplated. The rotational mount 46 is located centrally in the width-wise direction proximate the upper edge of the front carriage plate 40 and rear carriage plate 38. The front carriage plate 40 is rotatable about its upper edge on the rotational mount 46 relative to the rear carriage plate 38.

The rear carriage plate 38 is secured to the cylinder 34 and the rollers 36 are secured to the rear face of the rear carriage plate 38 such that the rear carriage plate 38 is slidingly received in and vertically guided by the guide slots 26 of the mast assembly 14. The rear carriage plate 38 is therefore rotationally fixed relative to the mast assembly 14, and transversely fixed relative to both uprights of the mast assembly 14 and the truck 2.

As shown in FIG. 4 a pin 48 extends from the rear face of the front carriage plate 40. The pin 48 extends through a slot 50 formed in the rear carriage plate 38. The pin 48 is transversely aligned with the rotational mount 46 and is located a spaced distance vertically beneath the rotational mount 46 proximate the lower edge of the front carriage plate 40. The slot 50 is arcuate having a radius equal to the distance of the centre of the pin 48 from the centre of the rotational mount 46. A hydraulic cylinder 52 is mounted to the rear face of the rear carriage plate 38. The proximal fixed end of the cylinder 52 is secured to the rear face of the rear carriage plate 38 at a height corresponding to the base or inflection point of the arcuate slot 50 and laterally spaced from the slot 50. The proximal end 54 of the cylinder 52 is rotationally mounted to the rear carriage plate 38. The opposing distal end 56 is rotationally mounted to the pin 48.

Linear extension or retraction of the cylinder 52 causes corresponding pulling or pushing motion on the pin 48. This causes the front carriage plate 40 to rotate about the rotational mount 46 with the pin 48 sliding in an arcuate motion within the slot 50 which acts to guide and restrain the pin 48 during movement. As the point of actuating engagement in the form of the pin 48 is spaced from the rotational mount 46 defining the pivot axis, a linear actuator is able to be used to provide a rotational movement. The spacing of the pin 48 from the pivot axis defines a moment arm, and due to the pin being substantially spaced across the carriage plate from the pivot axis the actuating force required to rotate the plate is minimised due to the moment arm being maximised. As such significantly less power is required than would be necessary if a direct rotational force were to be applied to the carriage plates, for example via a rotational drive shaft.

A vehicle attitude sensor (not shown) is provided that is mounted to the truck 2. The vehicle attitude sensor is arranged to detect both the lateral and fore and aft attitude of the truck 2, and may be any device suitable for determining this information. Preferably the attitude sensor includes at least one gyroscope and at least one accelerometer, and more preferably the attitude sensor includes a plurality of accelerometers and a plurality of gyroscopes. When the truck 2 is in a transversely and longitudinally horizontal attitude the front carriage plate 40 and the rear carriage plate 38 are aligned such that load sections 32 of the forks 30 are horizontal and parallel to the ground. The output signal from the vehicle attitude sensor is provided to a controller. When the controller determines that the lateral attitude of the truck 2 is not horizontal, based on the signal from the vehicle attitude sensor, the controller provides a signal to a hydraulic valve block connected to the hydraulic supply line to the hydraulic cylinder 52. The controller controls the cylinder 52 move and rotate the front carriage plate 40 relative to the rear carriage plate 38 to maintain front carriage plate 40 and hence the fork 32 in a horizontal attitude. The degree and direction to which front carriage plate 40 is rotated by the cylinder 52 is determined by the controller with the controller controlling the hydraulic valve block to extend or retract the cylinder 52 accordingly.

The vehicle attitude sensor also detects the horizontal attitude of the truck 2 in the longitudinal fore and aft direction. The controller is also connected to the cylinders 18 to control rotational movement of the mast assembly 14 to vary the fore and aft attitude of the mast assembly 14. The controller is therefore able to pivot the mast assembly forwardly or rearwardly in response to a change in the longitudinal horizontal attitude of the truck to maintain the horizontal attitude of the forks 30.

The attitude sensors in the control module are able to detect very minute changes in the attitude of the fork lift truck. When such a change is detected by the sensors the controller sends a control signal to the relevant actuators to cause the actuators to alter the attitude of the forks accordingly to maintain a level attitude of the load. This is a constantly updating process and only the averaged angle of lean determined from the sensors is used to provide hysteresis damping to prevent the actuators from jittering due to overly rapid response.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A load handling apparatus for a load handling vehicle comprising:
a rear load handling section including mounting means for securing the rear load handling section to the lifting mechanism of a forklift mast assembly;
a front load handling section which in use supports the load, rotatably mounted to the rear load handling section, such that the front load handling section is able to rotate relative to the rear load handling section, the load handling apparatus having a lateral axis transverse to the rotational axis of the front load handling section;
actuating means arranged to rotate the front load handling section relative to the rear load handling section;
an attitude sensor configured to provide a signal indicative of the lateral attitude of the rear load handling section relative to the horizontal; and
a controller configured to automatically control the actuating means in response to a signal from the attitude sensor to rotate the front load handling section relative to the rear load handling section to optimize load stability.

2. The load handling apparatus according to claim 1, wherein the controller determines the optimum rotational position of the front load handling section required to optimise load stability.

3. The load handling apparatus according to claim 1, wherein the controller is configured to automatically actuate the front load handling section to a substantially laterally horizontal attitude in response to a signal from the attitude sensors.

4. The load handling apparatus according to claim 3 further comprising at least one inertial sensor for sensing lateral inertial forces;
wherein the controller is configured to determine the optimum rotational position of the front load handling section based on both the lateral horizontal attitude of the rear lead handling plate and the detected inertial force.

5. The load handling apparatus according to preceding claim 1, wherein the front load handling section comprises a support plate and at least two lifting tines mounted to and extending perpendicularly away from the front face of the support plate in a spaced arrangement.

6. The load handling apparatus according to claim 5, wherein the rear load handling section comprises a support plate arranged substantially parallel to the front support plate and wherein the mounting means are secured to the rear face of the rear support plate.

7. The load handling apparatus according to claim 1, wherein the front load handling section is rotatably mounted to the rear load handling section by a rotational mounting and the actuating means is a linear actuator having a first end rotatably mounted to the rear load handling section and a second end rotatable mounted to the front load handling section at a location radially spaced from the rotational mounting such that linear actuation of the actuator causes rotational movement of the front load handling section relative to the rear load handling section about the rotational mounting.

8. The load handling apparatus according to claim 7, wherein a projection extends from the rear face of the front load handling section at a location radially spaced from the rotational mounting to which the second end of the linear actuator is rotatably mounted.

9. The load handling apparatus according to claim 8, wherein the linear actuator is mounted to the rear face of the rear load handling section and the rear load handling section comprises an arcuate slot through which the projection of the front section extends, the slot having a radius corresponding to the radial distance of the projection from the rotational axis of the rotational mounting.

10. The load handling apparatus according to claim 9, wherein the load handling apparatus has a longitudinal axis extending parallel to the rotational axis of the rotational mounting which in use aligns with the longitudinal axis of the load handling vehicle with the longitudinal horizontal attitude of the front load handling section being define by the position in which the longitudinal axes of the lifting tines are horizontally arranged, wherein the attitude sensor is configured to provide a signal to the controller indicative of the longitudinal horizontal attitude of the vehicle, and the controller is configured to generate a control signal in response to said signal to in use control the mast assembly actuator of a forklift truck to alter the in a longitudinal attitude of front load handling section relative to the horizontal to optimise load stability.

11. The load handling apparatus according to claim 10, wherein the controller determines the optimum longitudinal attitude of the front load handling section relative to the horizontal to optimise load stability.

12. The load handling apparatus according to claim 1, wherein the attitude sensor comprises at least one gyroscope and at least one accelerometer.

13. A load handling vehicle comprising the load handling apparatus according to claim 1.

14. The load handling vehicle according to claim 13 further comprising:
a vehicle body;
a mast assembly pivotally mounted to the vehicle body and slidingly mounted to the rear load handling section;
a mast assembly actuator arranged to pivot the mast assembly relative to the body; and
a lifting actuator connected to the rear load handling section and a connected to raise and lower the rear load handling section along the length of the mast assembly;
wherein the front load handling section comprises a support plate and at least two lifting tines mounted to and extending perpendicularly away from the front face of the support plate in a spaced arrangement, and the load handling apparatus has a longitudinal axis extending parallel to the rotational axis of the rotational mounting with the longitudinal horizontal attitude of the front load handling section being define by the position in which the longitudinal axes of the lifting tines are horizontally arranged; and
wherein the controller is configured to automatically control the mast actuator in response to a signal from the attitude sensor indicative of the longitudinal horizontal attitude to move to the lifting tines to a horizontal attitude.

15. The load handling vehicle according to claim 14, wherein the controller is configured to determine the velocity of the vehicle and to override the vehicle controls and decelerate the vehicle when it is determined that the velocity exceeds maximum load stability parameters.
